(19) United States
(12) Patent Application Publication
(10) Pub. No.: US 2008/0244238 A1
(43) Pub. Date: Oct. 2, 2008

(54) Stream processing accelerator

(76) Inventor: Bogdan Mitu, Campbell, CA (US)

Correspondence Address: HAVERSTOCK & OWENS LLP, 162 N WOLFE ROAD, SUNNYVALE, CA, 94086, US

(21) Appl. No.: 11/897,672

(22) Filed: Aug. 30, 2007

Related U.S. Application Data
(60) Provisional application No. 60/841,888, filed on Sep. 1, 2006.

(51) Int. Cl. G06F 9/30

(52) U.S. Cl. 712/220; 712/E09.016

(57) ABSTRACT

The present invention is a stream processing accelerator which includes multiple coupled processing elements which are interconnected through a shared file register and a set of global predicates. The stream processing accelerator has two modes: full-processor mode and circuit mode. In full-processor mode, a branch unit, an arithmetic logic unit and a memory unit work together as a regular processor. In circuit mode, each component acts like functional units with configurable interconnections.

### RELATED APPLICATION(S)

This patent application claims priority under 35 U.S.C. §119(e) of the co-pending, co-owned U.S. Provisional Patent Application No. 60/841,888, filed Sep. 1, 2006, and entitled “INTEGRAL PARALLEL COMPUTATION” which is also hereby incorporated by reference in its entirety.

This patent application is related to U.S. patent application Ser. No. ______, entitled “INTEGRAL PARALLEL MACHINE”, [Attorney Docket No. CONX-00101] filed which is also hereby incorporated by reference in its entirety.

### FIELD OF THE INVENTION

The present invention relates to the field of data processing. More specifically, the present invention relates to data processing using a set of processing elements with a global file register and global predicates.

### BACKGROUND OF THE INVENTION

Computing workloads in the emerging world of “high definition” digital multimedia (e.g. HDTV and HD-DVD) more closely resembles workloads associated with scientific computing, or so called supercomputing, rather than general purpose personal computing workloads. Unlike traditional supercomputing applications, which are free to trade performance for super-size or super-cost structures, entertainment supercomputing in the rapidly growing digital consumer electronic industry imposes extreme constraints of both size and cost.

With rapid growth has come rapid change in market requirements and industry standards. The traditional approach of implementing highly specialized integrated circuits (ASICs) is no longer cost effective as the research and development required for each new application specific integrated circuit is less likely to be amortized over the ever shortening product life cycle. At the same time, ASIC designers are able to optimize efficiency and cost through judicious use of parallel processing and parallel data paths. An ASIC designer is free to look for explicit and latent parallelism in every nook and cranny of a specific application or algorithm, and then exploit that in circuits. With the growing need for flexibility, however, an embedded parallel computer is needed that finds the optimum balance between all of the available forms of parallelism, yet remains programmable.

Embedded computation requires more generality/flexibility than that offered by an ASIC, but less generality than that offered by a general purpose processor. Therefore, the instruction set architecture of an embedded computer can be optimized for an application domain, yet remain “general purpose” within that domain.

### SUMMARY OF THE INVENTION

The present invention is a stream processing accelerator which includes multiple coupled processing elements which are interconnected through a shared file register and a set of global predicates. The stream processing accelerator has two modes: full-processor mode and circuit mode. In full-processor mode, a branch unit, an arithmetic logic unit and a memory unit work together as a regular processor. In circuit mode, each component acts like functional units with configurable interconnections.

### BRIEF DESCRIPTION OF THE DRAWINGS

FIG. 1 illustrates a block diagram of a preferred embodiment of the present invention.

FIG. 2 illustrates a block diagram of a processing element functioning as a circuit.

FIG. 3 illustrates an exemplary unbalanced tree.

FIG. 4 illustrates a flowchart of a process of processing data using the present invention.

### DETAILED DESCRIPTION OF THE PREFERRED EMBODIMENT

A stream processing accelerator includes n processing elements (PEs), m registers organized as a global file register (GFR) used to exchange data between PEs and p global predicates used by the PEs as condition bits. Of the global predicates, one is selected by each PE and is available to the other PEs, while the rest of the global predicates are set by explicit instructions by any PE.

With multiple PEs communicating with the multiple registers within the GFR, it is possible to execute various instructions on data, thus providing a more efficient processing unit. Any PE can read/write to any of the registers within the GFR, providing flexibility as well.

Each PE is a two stage pipeline machine: fetch and decode; execute and write back. Each PE contains a local file register, an Arithmetic Logic Unit (ALU), a Branch Unit (BU), a Memory access Unit (MU), a program memory and a data memory.

Each PE can be configured to function in two different modes: full-processor mode or circuit mode. The method of changing modes preferably includes toggling a register bit. The modes are able to come pre-configured or configured later. Furthermore, since each PE is able to be configured independently, it is possible to have some PEs in full-processor mode and some in circuit mode.

In full-processor mode, the BU, the ALU and the MU work together as a regular processor. Furthermore, the PEs are able to work as a pipeline where some or all of the PEs are interconnected so that each PE uses data generated by the previous PE.

In circuit mode, each component acts like a functional unit with configurable interconnections. ALUs are used to implement the logic, MUs implement look-up tables, BUs implement state-machines, operand registers store the state of the circuit, instruction registers are configuration registers for BU, ALU and MU and special function registers provide an I/O connection.

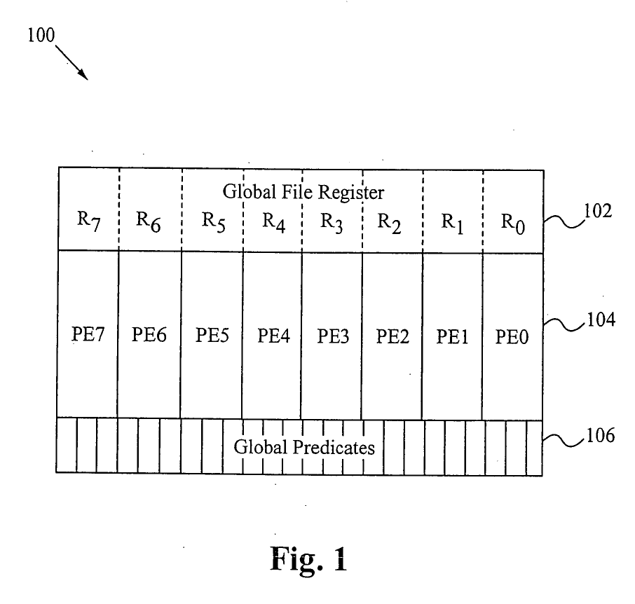

FIG. 1 illustrates a block diagram of a preferred embodiment of the present invention. A stream processing accelerator 100 includes a global file register (GFR) 102, a set of processing elements 104 and global predicates 106. The GFR 102 comprises a set of registers which are coupled to the set of PEs 104. The set of PEs 104 each read from and write to the GFR 102 when processing data. Furthermore, since any of the registers in the set of registers in the GFR 102 are accessible by any of the PEs 104, the stream processing accelerator 100 is highly configurable. For example, if there are 8 PEs 104 and 8 registers in the GFR 102, one configuration could utilize all 8 PEs 104 and all 8 registers in the GFR 102 for one dedicated task. However, another configuration could use 4 PEs 104 and 4 registers in the GFR 102 for one task and the other 4 PEs 104 and 4 registers in the GFR 102 for another task. Yet another configuration could have 7 PEs 104 and 7 registers in the GFR 102 for a more intensive task and 1 PE and register for a less intensive task. Any configuration is possible, and thus the stream processing accelerator 100 permits great flexibility.

By reading and writing in a specific order, the stream processing accelerator 100 can act like a pipeline. For example, the stream processing accelerator 100 can be configured such that PE₀ writes to register, R₀, and R₀ reads from PE₁ then PE₁ writes to register, R₁, and R₁ reads from PE₂, and so on. The last register, Rₙ, wraps around and reads from the first PE, PE₀. Thus, even sequential data is able to be processed efficiently via a pipeline.

The global predicates 106 used within the stream processing accelerator are preferably 1-bit flip-flops. Preferably, there are more global predicates 106 than PEs 104. For example, the stream processing accelerator 100 with 8 PEs 104 and 8 registers in the GFR 102 could have 32 global predicates 106. The first n global predicates are individually associated to each PE, where n is the number of PEs, such as 8. The other global predicates are set and/or tested by any PE in order to decide what action to take. For example, if a program has a branch and needs to compute the value of c[0] to determine which branch to take, a global predicate is able to be set to the value of c[0], and then the PEs that need to know that value are able to execute based on the value read in the global predicate. This provides a way to implement the efficient processing system as described in U.S. patent application Ser. No. ______, entitled “INTEGRAL PARALLEL MACHINE”, [Attorney Docket No. CONX-00101] filed ______, which is hereby incorporated by reference in its entirety.

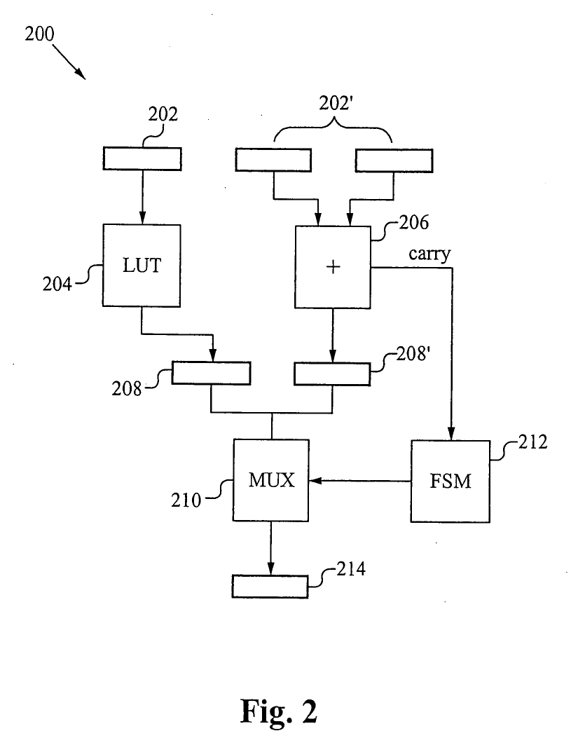

FIG. 2 illustrates a block diagram of a PE 200 functioning as a circuit. A first register 202 provides input to a look-up table (LUT) 204, and a first set of registers 202′, each provide an input to an arithmetic logic unit (ALU) 206. The LUT 204 is a data memory of a PE. Furthermore, the LUT 204 handles a very specific programmed function where the function is loaded into the data memory. The ALU 206 implements a standard function such as add or subtract. The result from the LUT 204 goes to a second register 208, and the result from the ALU 206 goes to a third register 208′. A MUX 210 then selects from the second register 208 and the third register 208′ based on a finite state machine (FSM) 212 which receives a carry from the ALU 206. The FSM 212 is a program memory which has a loop closed over a program counter. The selection from the MUX 210 is then output into a fourth register 214.

An additional mode of the PEs is tree mode which is accessible in full-processor mode. Utilizing the present invention, a PE is able to solve a very unbalanced tree. Tree mode is dedicated to Variable Length Decoding (VLD), and an example of VLD is Huffman coding. Huffman coding is an entropy encoding algorithm used for lossless data compression. The term refers to the use of a variable length code table for encoding a source symbol (such as a character in a file) where the variable-length code table has been derived in a particular way based on the estimated probability of occurrence for each possible value of the source symbol. In tree mode, the PE uses a different set of instructions optimized for fast bit processing. The PE will continuously read bits from a bit queue and advance in the VLD state tree until a terminated state is entered (meaning that a complete symbol was decoded). From a terminal state, the PE re-enters the full-processor mode, leaving a result value in a register.

The following is an exemplary VLC table:

TABLE 1
VLC table

| VL Code | Decoded Value |
|---|---|
| 1 | 7 |
| 010 | 11 |
| 0110 | 33 |
| 01110 | 80 |
| 01111 | 50 |
| 001 | 22 |
| 0001 | 5 |
| 00001 | 4 |
| 00000 | 91 |

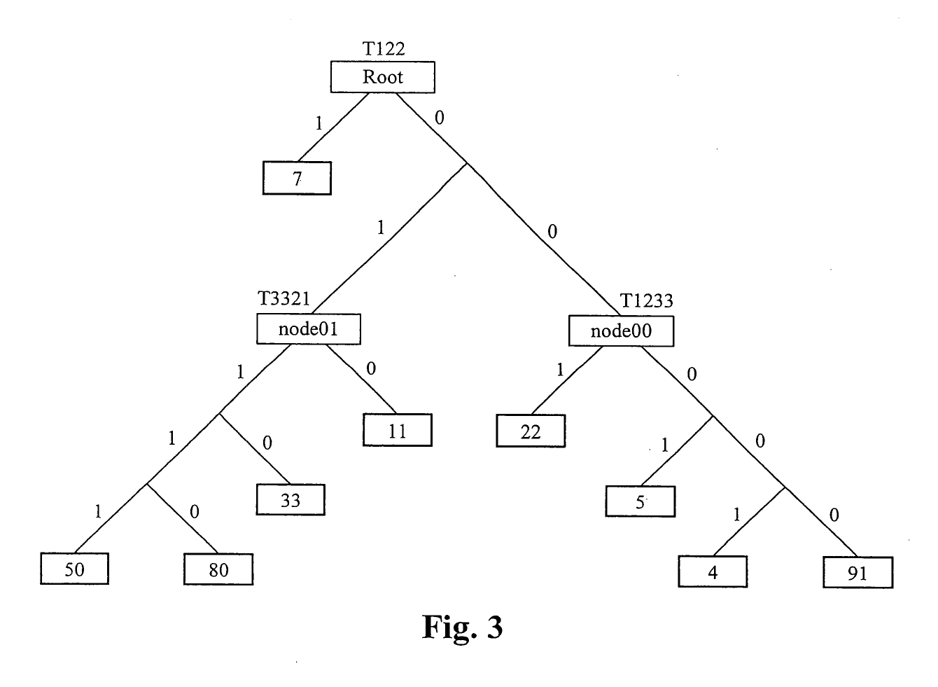

FIG. 3 illustrates an exemplary unbalanced tree. As can be seen by comparing FIG. 3 and Table 1, the terminals closer to the root have a smaller VL code.

During tree mode, a 32-bit instruction is divided into 4 sub-instructions, each having 1 byte. Based on the value of the top bits of a bit queue, one of the 4 sub-instructions will be executed. The number of bits read from the bit queue and the function used to select the sub-instruction are specified by a state register only used in the tree mode.

A bit is used to test and find an end result or state. The state result may be found in 1 clock cycle as in the left branch of the tree in FIG. 3, or in many cycles as in the right branch of the tree in FIG. 3. Until the final state is found, jumps are made in memory as described above. Data is processed until the end, and then the process returns to the main memory. The jumps in program memory are made based on a few bits so that the few bits are analyzed each clock cycle. This allows a stream of coded data to be analyzed quickly. In each clock cycle the instruction provides 4 next addresses. The address is selected according to an input bit. Then, the program counter will reach that address in 4 fills. A 32-bit instruction is divided by 4 and each 8 bits determines the next program counter.

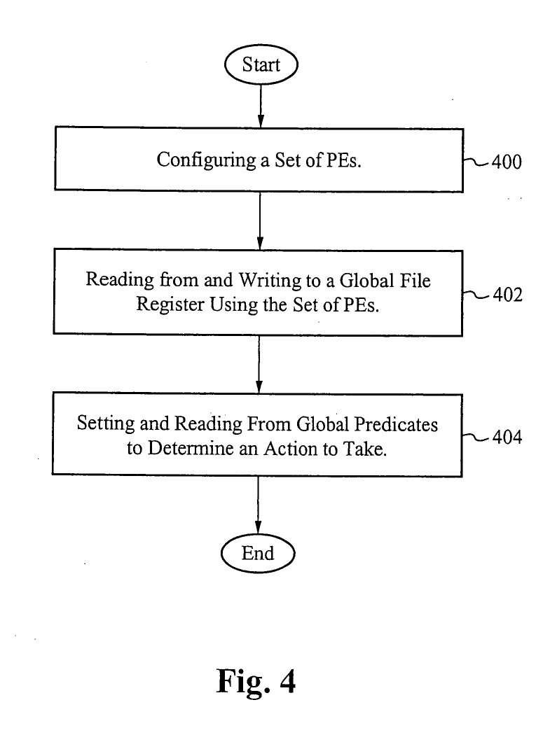

FIG. 4 illustrates a flowchart of a process of processing data using the stream processing accelerator. In the step 400, the PEs, the GFR and the global predicates are configured as desired. Alternatively, the PEs, GFR and global predicates are pre-configured. The stream processing accelerator is able to be configured in a number of different ways including whether to function in full-processor mode or circuit mode. The configuration of PEs with the registers within the GFR is also able to be modified. As described, if there are 8 PEs, it is possible to separate them into various groups to execute different instructions and process varying data. In the step 402, the PEs read from and write to the GFR as the PEs process data. As described above, the process of reading from and writing to the GFR depends on the mode whether it be full-processor or circuit mode. For example, in full-processor mode, the PEs and GFR function as a standard processor. However, in circuit mode, the components each have a specific function. In the step 404, the PEs also reference global predicates to process the data where branches or jumps occur. For example, if a PE needs to know a result or value, then that data is able to be stored in a global predicate and then retrieved by the PE when necessary.

In an exemplary embodiment, the GFR includes 8 16-bit registers shared by all 8 PEs. If one or more PEs are in circuit mode, then each individual ALU or MU can access the GFR. A write to the GFR requires passing data through an additional pipeline register, so writes to the GFR are performed 1 clock cycle later than local file register writes. Local file register writes are performed in the execute stage, while GFR writes are performed in the write-back stage.

Although any individual PE (or any ALU/MU in circuit mode) can access the global file register, there are some restrictions on the number of simultaneous accesses permitted. From each PE in circuit mode, only one of the two units (ALU and MU) is allowed to write in the global file register at any given time. In case of a conflict, only MU will write. The restriction does not apply to the full-processor mode because full-processor mode instructions only have one result. For each PE in circuit mode, an ALU left operand register and an MU address register cannot be both global registers. For each PE in circuit mode, an ALU right operand register and an MU data register (for STORE operations) cannot be both global registers.

As described above, the global predicates are used by branch units executing branch instructions. A branch instruction can test up to 2 predicates at a time in order to decide if the branch is taken. The predicates include 6 flags from each PE and 16 global flags. The global flags can be modified by any PE using set and clear instructions.

To utilize the present invention, a set of PEs is coupled to a GFR and global predicates for processing data efficiently. The present invention is able to implement PEs in two separate modes, full-processor mode and circuit mode. In addition to setting a mode, the configuration of PEs is also modifiable. For example, a first subset of PEs is set to circuit mode and a second subset of PEs are set to full-processor mode. Additionally, subsets can be set to full-processor mode or circuit mode with equal or different numbers of PEs in each subset. After the mode and configuration are selected, or pre-selected, the present invention processes data accordingly by reading and writing to the GFR.

In operation, the present invention processes data using the PEs, GFR and global predicates. The PEs read from and write to the GFR in a manner that efficiently processes the data. Furthermore, the global predicates are utilized when branch instructions are encountered wherein a PE determines the next step based on the value in the global predicate.

There are many uses for the present invention, in particular where large amounts of data is processed. The present invention is very efficient when processing long streams of data such as in graphics and video processing, for example HDTV and HD-DVD.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A system for processing data comprising:
a. a global file register;
b. a set of processing elements coupled to the global file register, wherein the set of processing elements execute instructions; and
c. a set of global predicates coupled to the set of processing elements, wherein the set of global predicates store condition data.

2. The system as claimed in claim 1 wherein the global file register is used to exchange data between the set of processing elements and the set of global predicates.

3. The system as claimed in claim 1 wherein the global file register further comprises a set of registers.

4. The system as claimed in claim 3 wherein any processing element in the set of processing elements is able to read from and write to any register of the set of registers.

5. The system as claimed in claim 1 wherein within the set of global predicates, a first subset of global predicates is associated with the set of processing elements and a second subset of global predicates is set by a conditional instruction by any of the processing elements within the set of processing elements.

6. The system as claimed in claim 1 wherein each processing element within the set of processing elements contains a local file register, an arithmetic logic unit, a branch unit, a memory access unit, a program memory and a data memory.

7. The system as claimed in claim 1 wherein each processing element within the set of processing elements has dual mode capabilities.

8. The system as claimed in claim 1 wherein each processing element within the set of processing elements functions in a mode selected from the group consisting of circuit mode and full-processor mode.

9. The system as claimed in claim 8 wherein the processing elements within the set of processing elements continuously execute a 1-instruction program in the circuit mode.

10. The system as claimed in claim 1 wherein the processing elements within the set of processing elements are interconnected so that each processing element uses the data generated by a previous processing element.

11. The system as claimed in claim 1 wherein the processing elements within the set of processing elements are pipelined.

12. The system as claimed in claim 1 wherein the set of processing elements is separated into two or more subsets of processing elements.

13. The system as claimed in claim 12 wherein a size of the two or more subsets of processing elements is unequal.

14. The system as claimed in claim 12 wherein a first processing element in one of the two or more subsets of processing elements is in circuit mode and a second processing element in one of the two or more subsets of the processing elements is in full-processor mode.

15. A system for processing data comprising:
a. a set of registers;
b. a set of dual mode processing elements coupled to the set of registers, wherein the set of dual mode processing elements execute instructions and further wherein each processing element of the set of dual mode processing elements reads from and writes to any register of the set of registers; and
c. a set of global predicates coupled to the set of dual mode processing elements, wherein the set of global predicates store condition data.

16. The system as claimed in claim 15 wherein the set of registers is used to exchange data between the set of dual mode processing elements and the set of global predicates.

17. The system as claimed in claim 15 wherein within the set of global predicates, a first subset of global predicates is associated with the set of dual mode processing elements and a second subset of global predicates is set by a conditional instruction by any of the processing elements within the set of dual mode processing elements.

18. The system as claimed in claim 15 wherein each processing element within the set of dual mode processing elements contains a local file register, an arithmetic logic unit, a branch unit, a memory access unit, a program memory and a data memory.

19. The system as claimed in claim 15 wherein the dual mode processing elements include a circuit mode and a full-processor mode.

20. The system as claimed in claim 19 wherein the processing elements within the set of dual mode processing elements continuously execute a 1-instruction program in the circuit mode.

21. The system as claimed in claim 15 wherein the processing elements within the set of dual mode processing elements are interconnected so that each processing element uses the data generated by a previous processing element.

22. The system as claimed in claim 15 wherein the processing elements within the set of dual mode processing elements are pipelined.

23. The system as claimed in claim 15 wherein the set of dual mode processing elements is separated into two or more subsets of processing elements.

24. The system as claimed in claim 23 wherein a size of the two or more subsets of processing elements is unequal.

25. The system as claimed in claim 23 wherein a first processing element in one of the two or more subsets of processing elements is in circuit mode and a second processing element in one of the two or more subsets of the processing elements is in full-processor mode.

26. A pipeline system for processing data comprising:
a. a set of n registers;
b. a set of n processing elements coupled to the set of n registers; and
c. a set of global predicates coupled to the set of processing elements, wherein the set of global predicates store condition data,
wherein the nth processing element in the set of n processing elements writes to the nth register in the set of n registers and the nth register in the set of n registers reads from the (n+1)th processing element in the set of n processing elements.

27. The pipeline system as claimed in claim 27 wherein within the set of global predicates, a first subset of global predicates is associated with the set of n processing elements and a second subset of global predicates is set by a conditional instruction by any of the processing elements within the set of n processing elements.

28. The pipeline system as claimed in claim 27 wherein each processing element within the set of n processing elements contains a local file register, an arithmetic logic unit, a branch unit, a memory access unit, a program memory and a data memory.

29. The pipeline system as claimed in claim 27 wherein the set of n processing elements is separated into two or more subsets of processing elements.

30. The pipeline system as claimed in claim 29 wherein a size of the two or more subsets of processing elements is unequal.

31. A method of processing data comprising:
a. configuring a set of processing elements;
b. reading from and writing to a global register file using the set of processing elements; and
c. setting and reading from a set of global predicates to determine an action to take.

32. The method as claimed in claim 31 wherein the global file register is used to exchange data between the set of processing elements and the set of global predicates.

33. The method as claimed in claim 31 wherein the global file register comprises a set of registers.

34. The method as claimed in claim 33 wherein any processing element in the set of processing elements is able to read from and write to any register of the set of registers.

35. The method as claimed in claim 31 wherein within the set of global predicates, a first subset of global predicates is associated with the set of processing elements and a second subset of global predicates is set by a conditional instruction by any of the processing elements within the set of processing elements.

36. The method as claimed in claim 31 wherein each processing element within the set of processing elements contains a local file register, an arithmetic logic unit, a branch unit, a memory access unit, a program memory and a data memory.

37. The method as claimed in claim 31 wherein each processing element within the set of processing elements has dual mode capabilities.

38. The method as claimed in claim 31 wherein each processing element within the set of processing elements functions in a mode selected from the group consisting of circuit mode and full-processor mode.

39. The method as claimed in claim 38 wherein the processing elements within the set of processing elements continuously execute a 1-instruction program in the circuit mode.

40. The method as claimed in claim 31 wherein the processing elements within the set of processing elements are interconnected so that each processing element uses the data generated by a previous processing element.

41. The method as claimed in claim 31 wherein the processing elements within the set of processing elements are pipelined.

42. The method as claimed in claim 31 wherein the set of processing elements is separated into two or more subsets of processing elements.

43. The method as claimed in claim 42 wherein a size of the two or more subsets of processing elements is unequal.

44. The method as claimed in claim 42 wherein a first processing element in one of the two or more subsets of processing elements is in circuit mode and a second processing element in one of the two or more subsets of the processing elements is in full-processor mode.
